(19) United States
(12) Patent Application Publication
(10) Pub. No.: US 2008/0275582 A1
(43) Pub. Date: Nov. 6, 2008

(54) Scheduling AMHS pickup and delivery ahead of schedule

(76) Inventors: Steven C. Nettles, Johnson City, TX (US); Achim Felber, Buda, TX (US); Marlin L. Shopbell, Buda, TX (US); Joerg Luebke, Dresden (DE); Lok Tau, Austin, TX (US)

Correspondence Address: WILLIAMS, MORGAN & AMERSON, 10333 RICHMOND, SUITE 1100, HOUSTON, TX, 77042, US

(21) Appl. No.: 10/992,962

(22) Filed: Nov. 19, 2004

(51) Int. Cl. G06F 19/00

(52) U.S. Cl. 700/100

(57) ABSTRACT

A method and apparatus for use in scheduling in an automated process flow such that vehicles for a material transport are staged prior to the commencement of an appointment for the transport are disclosed. The method includes scheduling a material transport in the process flow; and requesting a staging of a vehicle for the material transport a predetermined time period prior to the material transport. The apparatus, in various aspects, includes a computer and computing system programmed to perform the method in an automated process flow as well as a computer-readable program storage medium encoded with instruction that, when executed, perform such a method.

### BACKGROUND OF THE INVENTION

1. Field of the Invention

This invention pertains to automated manufacturing environments, and, more particularly, to scheduling in an automated manufacturing environment.

2. Description of the Related Art

Growing technological requirements and the worldwide acceptance of sophisticated electronic devices have created an unprecedented demand for large-scale, complex, integrated circuits. Competition in the semiconductor industry requires that products be designed, manufactured, and marketed in the most efficient manner possible. This requires improvements in fabrication technology to keep pace with the rapid improvements in the electronics industry. Meeting these demands spawns many technological advances in materials and processing equipment and significantly increases the number of integrated circuit designs. These improvements also require effective utilization of computing resources and other highly sophisticated equipment to aid, not only design and fabrication, but also the scheduling, control, and automation of the manufacturing process.

Turning first to fabrication, integrated circuits, or microchips, are manufactured from modern semiconductor devices containing numerous structures or features, typically the size of a few micrometers. The features are placed in localized areas of a semiconducting substrate, and are either conductive, non-conductive, or semi-conductive (i.e., rendered conductive in defined areas with dopants). The fabrication process generally involves processing a number of wafers through a series of fabrication tools. Each fabrication tool performs one or more of four basic operations discussed more fully below. The four basic operations are performed in accordance with an overall process to finally produce the finished semiconductor devices.

Integrated circuits are manufactured from wafers of a semiconducting substrate material. Layers of materials are added, removed, and/or treated during fabrication to create the integrated, electrical circuits that make up the device. The fabrication essentially comprises the following four basic operations:
layering, or adding thin layers of various materials to a wafer from which a semiconductor is produced;
patterning, or removing selected portions of added layers;
doping, or placing specific amounts of dopants in selected portions of the wafer through openings in the added layers; and

heat treating, or heating and cooling the materials to produce desired effects in the processed wafer.

Although there are only four basic operations, they can be combined in hundreds of different ways, depending upon the particular fabrication process. See, e.g., Peter Van Zant, Microchip Fabrication, A Practical Guide to Semiconductor Processing (3d Ed. 1997 McGraw-Hill Companies, Inc.) (ISBN 0-07-067250-4).

Efficient management of a facility for manufacturing products such as semiconductor chips requires monitoring various aspects of the manufacturing process. For example, it is typically desirable to track the amount of raw materials on hand, the status of work-in-process and the status and availability of machines and tools at every step in the process. One of the most important decisions is selecting which lot should run on each machine at any given time. Additionally, most machines used in the manufacturing process require scheduling of routine preventative maintenance (“PM”) and equipment qualification (“Qual”) procedures, as well as other diagnostic and reconditioning procedures that must be performed on a regular basis, such that the performance of the procedures does not impede the manufacturing process itself.

One approach to this issue implements an automated “Manufacturing Execution System” (“MES”). Examples of commercially available MES systems include WORKSTREAM™, available from Applied Materials, Inc., and SIVIEW™, available from International Business Machines, Inc. An automated MES enables a user to view and manipulate, to a limited extent, the status of machines and tools, or “entities,” in a manufacturing environment. In addition, an MES enables the dispatching and tracking of lots or work-in-process to enable resources to be managed in the most efficient manner.

Specifically, in response to MES prompts, a user inputs requested information regarding work-in-process and entity status. For example, when a user performs a PM on a particular entity, the operator logs the performance of the PM (an “event”) into an MES screen to update the information stored in the MES database with respect to the status of that entity. Alternatively, if an entity is to be put down for repair or maintenance, the operator will log this information into the MES database, which then prevents use of the entity until it is subsequently logged back up.

Although MES systems sufficient for tracking lots and machines, such systems suffer several deficiencies, the most obvious of which are their passive nature, lack of advance scheduling, and inability to support highly automated factory operations. Current MES systems largely depend on manufacturing personnel for monitoring factory state and initiating activities at the correct time. For example, a lot does not begin processing until a wafer fab technician (“WFT”) issues the appropriate MES command. And, prior to processing, a WFT must issue an MES command to retrieve the lot from the automated material handling system (“AMHS”) with sufficient advance planning that the lot is available at the machine when the machine becomes available. If the WFT does not retrieve the lot soon enough, or neglects to initiate processing at the earliest available time, the machine becomes idle and production is adversely impacted.

Another approach to facility management employs an AMHS, briefly mentioned above, typically in conjunction with a MES. An AMHS transports materials from one point to another in the process flow. For instance, in a semiconductor fabrication facility (“fab”), once a lot of wafers is finished processing on a particular process tool, it is usually desirable to remove the lot from the port of the process tool at the first opportunity. As soon as the WFT receives notification that the lot is done and waiting, he issues a command to the AMHS to send an empty vehicle to carry the lot to its next destination. Several minutes might elapse in the time it takes for the notification to be sent and received, for the WFT to issue the command, and for the vehicle to arrive. While this may not seem like much, the delay can add up quite quickly in the aggregate. For instance, in a process flow of 750 process operations, a delay of 3 minutes per operation results in a cumulative delay of 37.5 hours.

The present invention is directed to resolving, or at least reducing, one or all of the problems mentioned above.

### SUMMARY OF THE INVENTION

The invention, in its various aspects and embodiments, is a method and apparatus for use in scheduling in an automated process flow such that vehicles for a material transport are staged prior to the commencement of an appointment for the transport. The method comprises scheduling a material transport in the process flow; and requesting a staging of a vehicle for the material transport a predetermined time period prior to the material transport. The apparatus, in various aspects, includes a computer and computing system programmed to perform the method in an automated process flow as well as a computer-readable program storage medium encoded with instruction that, when executed, perform such a method.

### BRIEF DESCRIPTION OF THE DRAWINGS

The invention may be understood by reference to the following description taken in conjunction with the accompanying drawings, in which like reference numerals identify like elements, and in which:

FIG. 1 conceptually depicts a portion of one particular embodiment of a process flow constructed and operated in accordance with the present invention;

FIG. 2 illustrates one particular embodiment of a method practiced in accordance with the present invention;

FIG. 3 conceptually depicts, in a partial block diagram, selected portions of the hardware and software architectures, respectively, of the computing devices in FIG. 1;

FIG. 4 conceptually depicts a calendar of booked appointments; and

FIG. 5 conceptually illustrates a circumstance in which a booked appointment is changed to accommodate unexpectedly long durations for a preceding booked appointment; and

FIG. 6 conceptually depicts one particular implementation of the apparatus of FIG. 1, i.e., in a portion of a process flow from a semiconductor fabrication facility.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 conceptually illustrates a portion of one particular embodiment of a process flow 100 constructed and operated in accordance with the present invention. The process flow 100 fabricates semiconductor devices. However, the invention may be applied to other types of manufacturing processes. Thus, in the process flow 100 discussed above, the lots 130 of wafers 135 may more generically referred to as a “material” in the process flow 100. The process tools 115 and any process operation performed thereon need not necessarily be related to the manufacture of semiconductor devices in all embodiments. However, for the sake of clarity and to further an understanding of the invention, the terminology pertaining to semiconductor fabrication shall be retained in disclosing the invention in the context of the illustrated embodiments.

The illustrated portion of the process flow 100 includes two stations 105, each station 105 including a computing apparatus 110 communicating with a process tool 115. The stations 105 communicate with one another over communications links 120. In the illustrated embodiment, the computing apparatus 110 and the communications links 120 comprise a portion of a larger computing system, e.g., a network 125. The process tools 115 are shown in FIG. 1 processing lots 130 of wafers 135 that will eventually become integrated circuit devices. The process tool 115 may be a fabrication tool used to fabricate some portion of the wafers 135, i.e., layer, pattern, dope, or heat treat the wafers 135. Or, the process tool 115 may be a metrology tool used to evaluate the performance of various parts of the process flow 100.

The process flow 100 also includes portions of an MES 137, an automated materials handling system (“AMHS”) 138, a process resource (e.g., a WIP stocker) 150, and other integrated factory controls. For purposes of illustration, two process resources 155a, 155b are also shown. Both the MES 137 and the AMHS 138 include software components 141, 142, respectively. The AMHS 138 “handles” the lots 130 and facilitates their transport from one station 105 to another, as well as other locations in the process flow 100. The MES 137 and the process resources 150, 155a, 155b operate and are used in conventional fashion. The process resource 150 is a WIP stocker, and is used to store the lots 130 between process operations on the process tools 115. Note that, in alternative embodiments, the process resource 150 may be, e.g., a work-in-progress stocker, a work-in-progress rack, or an undertrack storage.

The transport of a material, e.g., a lot 130, from one point to another in the process flow 100 is sometimes also referred to as a “move.” The illustrated embodiments are set in the context of a “move” from one point, or source, to a second point, or destination. For instance, a lot 130 may be “moved” from the port 140 of a source, i.e., the process tool 115 of the port 140, to a destination, e.g., the process resource 150. In such a circumstance, the lot 130 will typically be moved to the process resource 150 closest to the process tool 115 on which the next process operation for the lot 130 will be performed. In general, there are four types of moves that may be seen: from a first process tool 115 to a first process resource 150, from the first process resource 150 to a second process tool 115, from a first process resource 155a to a second process resource 155b, from the second process resource 155b to a second process tool 115, and from the first process tool 115 to the second process tool 115.

More precisely, in a semiconductor fab, there are typically two types of material transports-interbay and intrabay material transports. Interbay material transports transport lots 130 between bays (not shown) of the manufacturing facility. Intrabay material transports transport lots 130 to different locations within the same bay. So, a typical material transport of a lot 130 from one process tool 115 to another process tool 115 in a different bay involves at least three material transports: an intrabay material transport from the port of a first process tool 115 to a stocker (not shown) in that tool's bay; an interbay material transport from that stocker to another stocker (also not shown) which is in the same bay as the second process tool 115; and the final intrabay material transport from that stocker to the port of the second process tool 115. Note that, in these embodiments, a material transport between two process tools 115 actually constitutes at least two constituent material transports, a material transport from a process tool 115 to, e.g., a stocker 150 or some other process resource, and a material transport from the WIP resource to the next process tool 115.

However, the invention is not limited to material transports between a process resource 150 and a process tool 115. Some embodiments may employ what is known as a “unified AMHS.” A unified AMHS permits material transports directly between process tools 115 without stopping at some intermediate WIP resource. Thus, in some embodiments, there may be only one material transport between process operations on different process tools 115. Consequently, there may not be a process resource 150 between the process tools 115 of the process flow 100 in alternative embodiments. In general, the following types of material transports may be found in a process flow such as the process flow 100:
from a first process tool 115 to a second process tool 115;
from a first process tool 115 to a process resource 150 and from the process resource 150 to a second process tool 115; and
from a first process tool 115 to a first process resource 155a, from the first process resource 155a to a second process resource 155b, and from the second process resource 155b to a second process tool 115.
   Note that the latter scenario can be extended to scenarios involving more than two process resources. However, in the illustrated embodiment, the material transports are scheduled by the constituent moves. Thus, in the illustrated embodiment, a material transport might be a material transport from:
a first process tool 115 to a process resource 150;
a first process resource 155a to a second process resource 155b;
the process resource 150 to the second process tool 115;
the second process resource 155b to a second process tool 115; and
the first process tool 115 to the second process tool 115.
   However, the list is illustrative, and neither exclusive nor exhaustive.

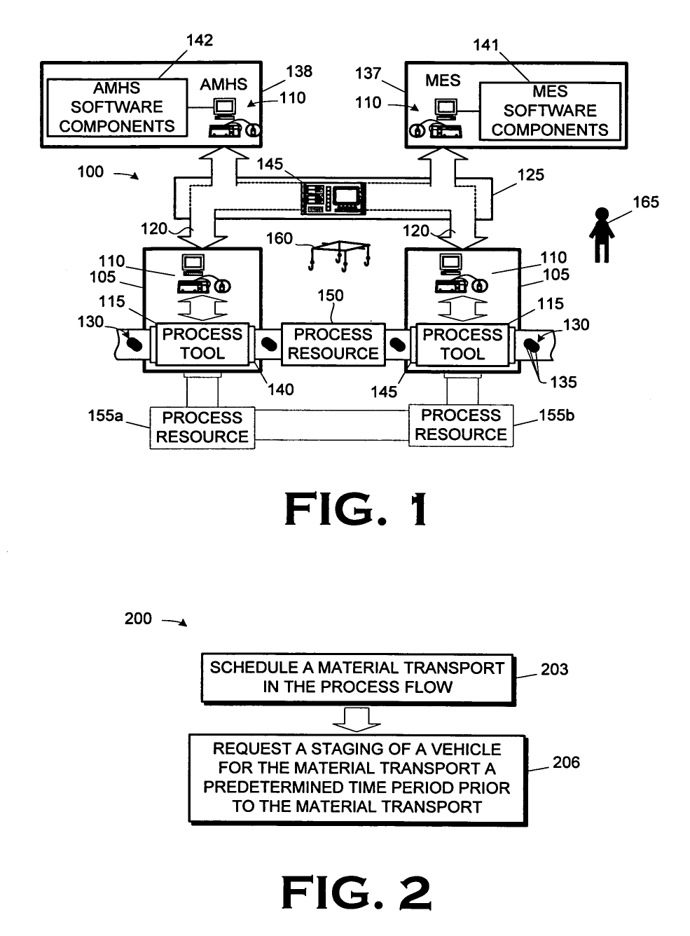

Turning now to FIG. 2, a method 200 in accordance with the present invention is illustrated. In general, the method 200 begins by scheduling (at 203) a material transport (e.g., a move of the lots 130, in FIG. 1) in the process flow (e.g., the process flow 100, in FIG. 1). In the illustrated embodiment, as is discussed more fully below, this more particularly includes scheduling ahead for an appointment for the material transport at some point in the future. The method 200 then requests (at 206) a staging of a vehicle 160 (i.e., having an empty vehicle at the source location for the move at the move start time) for the material transport a predetermined time period prior thereto. The type and nature of the vehicle 160 will be implementation specific and depend on a number of factors, such as the implementation of the AMHS 138 and the material to be transported.

For instance, in the illustrated embodiment, the material is a lot 130 of wafers 135, both shown in FIG. 1, disposed in a front-opening unified pod (“foup”) carrier (not shown). Thus, the vehicle 160 is a tracked, overhead vehicle. However, in some embodiments, the material may be, for instance, a reticle. In such an embodiment, the vehicle 160 may be a part of a reticle handling system such as is known in the art. The material may be implemented in still other ways in still other alternative embodiments, and the implementation of the vehicle 160 will vary accordingly. In a less than fully automated fab, a technician 165 may instead be directed to execute to transport the material, in which case the technician 165 may be considered the vehicle.

To further a greater understanding of the present invention, selected technical details of the illustrated embodiment shall be discussed. Returning to FIG. 1, as was mentioned above, the computing apparatus 110 may be part of a larger computing system 125 by a connection over the communications links 120. Exemplary computing systems in such an implementation would include local area networks (“LANs”), wide area networks (“WANs”), system area networks (“SANs”), intranets, or even the Internet. The computing system 125 employs a networked client/server architecture, and therefore includes a server 145, but alternative embodiments may employ a peer-to-peer architecture. Thus, in some alternative embodiments, the computing apparatus 110 may communicate directly with one another.

The communications links 120 may be wireless, coaxial cable, optical fiber, or twisted wire pair links, for example. The computing system 125, in embodiments employing one, and the communications links 120 will be implementation specific and may be implemented in any suitable manner known to the art. The computing system 125 may employ any suitable communications protocol known to the art, e.g., Transmission Control Protocol/Internet Protocol (“TCP/IP”).

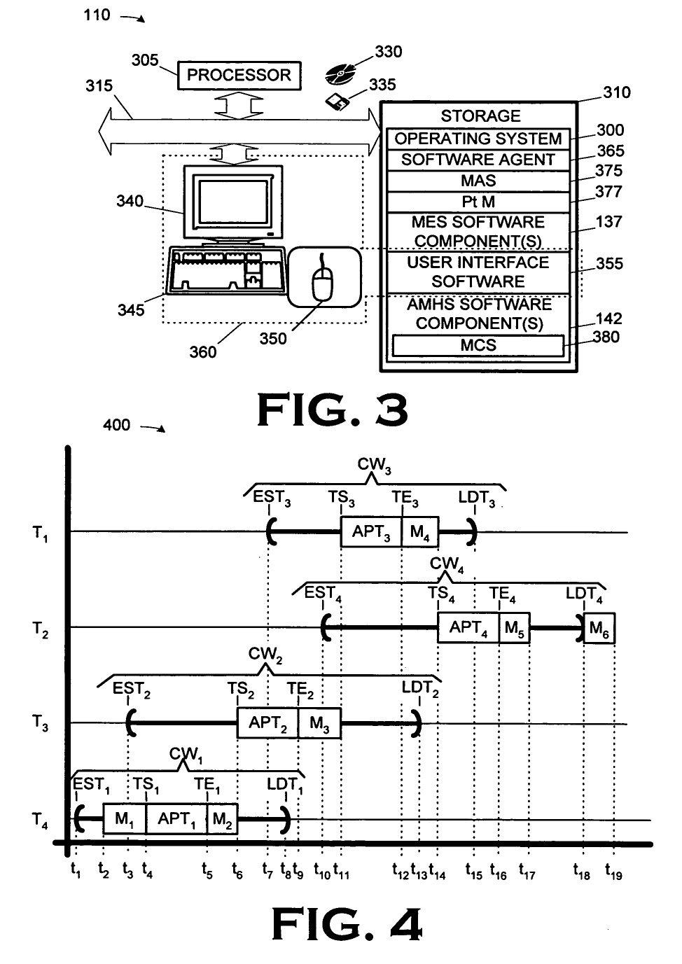

FIG. 3 depicts selected portions of the hardware and software architectures, respectively, of the computing apparatus 110 programmed and operated in accordance with the present invention. The computing system 125, shown in FIG. 1, is a distributed computing system that permits great flexibility in the situs of individual software components. For ease of illustration, FIG. 3 shows a number of software components of the process flow 100 resident on a single computing apparatus 110 that typically would reside on separate computing apparatus 110 in a given implementation. Conversely, some aspects of the hardware and software architecture (e.g., the individual cards, the basic input/output system (“BIOS”), input/output drivers, etc.) are not shown. These aspects are omitted for the sake of clarity, and so as not to obscure the present invention. As will be appreciated by those of ordinary skill in the art having the benefit of this disclosure, however, the software and hardware architectures of the computing apparatus 110 will include many such routine features.

In the illustrated embodiment, the computing apparatus 110 is a workstation, employing a UNIX-based operating system 300, but the invention is not so limited. The computing apparatus 110 may be implemented in virtually any type of electronic computing device such as a notebook computer, a desktop computer, a mini-computer, a mainframe computer, or a supercomputer. The computing apparatus 110 may even be, in some alternative embodiments, a processor or controller embedded in the process tool 115. The invention also is not limited to UNIX-based operating systems. Alternative operating systems (e.g., Windows™-based or disk operating system (“DOS”)-based) may also be employed. The invention is not limited by the particular implementation of the computing apparatus 110.

The computing apparatus 110 also includes a processor 305 communicating with storage 310 over a bus system 315. The storage 310 typically includes at least a hard disk (not shown) and random access memory (“RAM”) (also not shown). The computing apparatus 110 may also, in some embodiments, include removable storage such as an optical disk 330, or a floppy electromagnetic disk 335, or some other form, such as a magnetic tape (not shown) or a zip disk (not shown). The computing apparatus 110 includes a monitor 340, keyboard 345, and a mouse 350, which together, along with their associated user interface software 355 comprise a user interface 360. The user interface 360 in the illustrated embodiment is a graphical user interface (“GUI”), although this is not necessary to the practice of the invention.

Each computing apparatus 110 includes, in the illustrated embodiment, a software agent 365 residing in the storage 310. The particular computing apparatus 110 shown in FIG. 3 also includes a “move appointment scheduler” (“MAS”) 375 and a “port manager” 377, whose functions will be disclosed more fully below, residing in the storage 310. Note that the software agents 365, the MAS 375, and the port manager 377 may reside in the process flow 100 in places other than the computing apparatus 110. The situs of the software agents 365, the MAS 375, and the port manager 377 are not material to the practice of the invention. Note also that, since the situs is not material, some computing apparatus 110 may have multiple software agents 365, MAS 375, and port managers 377 residing thereon while other computing apparatus 110 may not have any. Software component(s) 141, 142 of the control system for an automated MES 137 and the AMHS 138 (shown first in FIG. 1), respectively, also reside on at least one computing apparatus 110. As with the software agent(s) 365, the MAS 375, and the port manager 377, the software components 141, 142 may reside anywhere within the process flow 100.

Referring now to FIG. 1 and FIG. 3, the software agents 365 each represent some “manufacturing domain entity,” e.g., a lot 130, a process tool 115, or a process resource 150. The software agents 365, schedule activities on behalf of and control the progress of the lots 130 of wafers 135 through the fabrication process. In furtherance of these objectives, the software agents 365 interface with the software components 141, 142 of the MES 137 and AMHS 138, and the process tools 115. The manner in which this interface and integration occurs is implementation specific, depending upon the makeup and configuration of the MES 137, AMHS 138, and the other factory control systems.

Collectively, the software agents 365, among other things, schedule ahead one or more processing operations for each lot 130 on a specific qualified process tool 115, including transports and required services. This includes making optimizing decisions such as running an incomplete batch, as opposed to waiting for approaching lots 130, and scheduling opportunistic preventive maintenance (“PM”) periods or qualification tests (“Quals”) to meet specifications. The software agents 365 schedule activities; initiate execution of scheduled activities (such as lot transport and processing); monitor factory states, appointment states, and alarm states in the factory that are relevant to the scheduled activities; and react to state changes arising from scheduled activities or unscheduled activities.

The software agents 365 schedule the lots 130 for processing on the process tools 115 and for material transports needed to arrive at the processing on time. Thus, there are at least two types of appointments that are scheduled—processing appointments and move appointments—although most embodiments will employ other types of appointments. The scheduling of material transports by the software agents 365 constitutes “scheduling a material transport in the process flow” (at 203, FIG. 2) in this particular embodiment.

The software agents 365 schedule ahead one or more process operations; i.e., they do not wait for a current process operation or material transport to finish before scheduling the next material transport or process operation. Typically, the software agents 365 schedule some number of process operations ahead, and the material transports are scheduled to meet the demands of the scheduled process operations. However, the precise number of process operations that are scheduled ahead will vary depending on factors such as the priority of the lots 130 being processed, advanced process control considerations, and pre-forming of batches.

An “appointment” is a time period certain in which some activity is scheduled to occur, and is defined by an Appointment Start Time (“TS”) and an Appointment End Time (“TE”). The appointment is typically defined within a “commitment window” (“CW”). A commitment window is a time window in which the process tool 115 commits to meet the “appointment” defined by an Earliest Start Time for processing (“EST”) and a Latest Delivery Time (“LDT”). Note that, as will be discussed further below, not all kinds of appointments have commitment windows. Nevertheless, for each appointment, the calendar 670 will store both the appointment [TS, TE] and its commitment window CW [EST, LDT], if applicable, and this stored information is used, in the illustrated embodiment, in formulating the bid.

FIG. 4 conceptually illustrates a calendar 400 storing information concerning processing appointments for a lot 130 on plurality of process tools 115. In FIG. 4, the lot 130 has booked processing appointments APP₁-APP₄ for process tools T₁-T₄, respectively. Thus, the calendaring information for the lot 130 is as follows:

T₁: APT₁[t₄, t₅], CW₁[t₁, t₈]

T₂: APT₂[t₆, t₉], CW₂[t₃, t₁₃]

T₃: APT₃[t₁₁, t₁₂], CW₃[t₇, t₁₅]

T4₂: APT₄ [t₁₄, t₁₆], CW₄ [t₁₀, t₁₉]

Note that several of the commitment windows overlap but none of the appointments do.

As was mentioned above, not every kind of appointment includes a “commitment window.” For instance, in the illustrated embodiment, move appointments for material transport to and from processing appointments do not include commitment windows, but only durations. Note, however, that alternative embodiments may employ commitment windows in which the move appointment may be executed. The calendar 400 also includes move appointments M₁-M₆ for material transport to and from the appointments APT₁-APT₄. A move appointment is defined by a duration and a transport start time, a transport delivery time, or both. Typically, the predetermined time at which the staging of a vehicle for a move appointment (e.g., the move appointment M₁) is defined relative to an appointment end time. Conversely, a move appointment (e.g., the move appointment M₂) for removing a lot 130 from a port 140 of a process tool 115 is defined relative to an appointment start time.

As will be discussed further below, a move appointment immediately preceding a processing appointment will have a scheduled transport end time that is the same as the scheduled start time of the processing appointment. The exception is for buffer tools that require carrier-in operation to load the processing tool 115 before the processing appointment. In this circumstance, the move appointment will have scheduled transport end time that is the same as the scheduled start time for the carrier-in appointment. Thus, the move appointments M₁-M₄ are scheduled to end at the time the respective subsequent processing appointments APT₁-APT₄ (or, in some circumstance, carrier-in appointment(s)) are scheduled to start.

Similarly, a move appointment immediately following a processing appointment will have a transport start time scheduled for the scheduled end time of the processing appointment. Again, the exception is for buffer tools that require carrier-out operation to unload the processing tool 115 after the processing appointment. In this circumstance, the move appointment will have scheduled transport start time that is the same as the scheduled end time for the carrier-out appointment. Thus, the move appointments M₂-M₅ are scheduled to start at the same time the processing appointments APT₁-APT₄ (or, in some circumstance, carrier-out appointment(s)) are scheduled to end. However, some embodiments may include a configurable arrival time prior to the processing appointment that defines the time at which materials are to be delivered to a given process tool 115 for processing.

Many techniques for scheduling appointments are known to the art, and any such technique may be employed. In one particular embodiment, however, appointments are scheduled using a contract net negotiation protocol in a floating market model approach. In the floating market model of the contract net negotiation protocol, the scheduling of actions initiated by the software agents 365 revolve around budgets, costs, and ratios associated with the processing in a contract net negotiation protocol. To further the implementation of a contract net negotiation protocol for allocating resources, a combination of budgets, costs, and ratios are used to implement a floating market model approach.

The combination of budgets, costs, and ratios is structured to encourage “desirable” behavior, e.g., meeting due dates, effective utilization of machines, etc. More particularly, a “budget” is assigned to the lots 130 that a software agent 365 uses to procure the process services. Similarly, the process tool 115, charges consumers for the processing services it represents, e.g., processing time. The amount of the budget the lot 130 is willing to pay depends on how badly it needs to stay on schedule and the amount charged by the process tool 115 depends on how badly it needs to fill its schedule. The lot 130 acquires services more or less aggressively depending on selected factors, such as priority or lateness. Process tools 115 provide such services more or less aggressively depending on a number of factors, such as the level of congestion in their calendars. Working in concert, the software agents 365 for consumers and providers of process services cooperate to advance the lots 130 through the process flow 100 in a timely and efficient manner.

FIG. 6 illustrates the negotiation for and scheduling of processing appointments in the process flow 100, which also includes scheduling moves to meet the processing appointments. In the illustrated embodiment, the process flow 100 includes at least two types of software agent 365:
a lot scheduling agent (“LSA”) 605 representing the lot 130 for scheduling purposes; and
a machine scheduling agent (“MSA”) 610 representing the process tool 115 for scheduling purposes.
   Although not shown, the illustrated embodiment also includes other types of agents.

For instance, the illustrated embodiment includes resource scheduling agents (“RSAs”, not shown) representing some process resources (e.g., reticles, dummy wafers, carriers, WFTs, maintenance technicians). The illustrated embodiment also includes PM scheduling agents (“PMSAs”, also not shown) representing tool PMs and Quals for scheduling purposes on respective process tools 115, neither of which are shown. PMSAs schedule maintenance and, where needed, qualification procedures performed regularly to keep a processing tool 115 in good working order. The lot 130, process tool 115, resources, and PMs and Quals all have corresponding “processing” agents, also not shown except for the lot processing agent (“LPA”) 695, to whom the scheduling agents pass control when it is time to initiate the execution of scheduled activities.

Each software agent 365 that schedules on behalf of some entity in the process flow 100 maintains a calendar, e.g., the calendar in FIG. 4, of appointments in the illustrated embodiment. For instance, the LSA 605 keeps a calendar 685 and the MSA 610 keeps a calendar 670. Similarly, PMs and Quals also have scheduling agents (not shown) for scheduling PMs and Quals for the process tools 115 of the process flow 100 on PM and Qual calendars (not shown). The type of appointments scheduled on any given calendar will depend largely on the nature of the entity that the software agent 365 that is keeping the calendar represents. Thus, the LSA 605 will keep the calendar 685 and store therein not only processing appointments such as the processing appointments APP₁-APP₄ in FIG. 4 for its respective lot 130, but also move appointments such as the move appointments M₁-M₆, also in FIG. 4. However, appointments for PMs and Quals (not shown) appearing on calendars for PMs, Quals, and process tools 115 will not appear on the calendar 685 kept by the LSA 605.

More particularly, the LSA 605 is responsible for scheduling current and future tasks on behalf of a specified lot 130 in the process flow 100. These tasks include manufacturing processing and material handling required to transform the lot 130 from raw silicon into a specified semiconductor product. A LSA 605 utilizes a calendar 685 to track scheduled tasks. The calendar 685 contains an ordered collection of appointments, e.g., the appointment 675, that represent active and future tasks scheduled by the LSA 605 that will provide the processing service required by the task. The LSA 605's calendar 685 may include various types of appointments including lot processing, carrier-in, carrier-out, move, feeder, and maximum move appointments. The types of appointments scheduled by the LSA 605 and a brief description thereof are summarized in Table 1. While these various appointment types contain different attributes, there are some attributes in common, including a scheduled start time, a scheduled end time, an estimated duration for how long the task will take and an appointment state.

TABLE 1
Appointments Booked by LSA

| Appt. Type | Appointment Description |
|---|---|
| Move | The lot is transported to a process tool. |
| Lot | The lot is processed on a process tool. |
| Carrier-in | The lot is loaded into a process tool. |
| Carrier-out | The lot is unloaded from a process tool. |
| Feeder | An appointment representing a scheduling constraint |
| | for operations between the current process operation |
| | and a process operation that has not yet been |
| | scheduled. |
| Maximum Move | An appointment that represents a scheduling |
| | constraint for moves of unknown duration between |
| | feeder and processing appointments where the tool |
| | to perform the processing operation represented by |
| | the feeder appointment is unknown. |

The MSA 610 also keeps a calendar 670 of appointments, e.g., the appointment 676, representing commitments of the process tool 115 to provide process services—namely, processing time. The types of appointments scheduled by the MSA 610 on the calendar 670 are set forth in Table 2. Note that there is no move appointment. Whereas the move appointment for a material transport explicitly constrains the scheduling of the LSA 605, it only implicitly, i.e., indirectly, constrains the scheduling by the MSA 610. Note, however, that the lot processing appointment 676 scheduled by the MSA 610 on the calendar 670 corresponds to the processing appointment 675 scheduled by the LSA 605 on the calendar 685.

TABLE 2
Appointments Booked by MSA

| Appt. Type | Appointment Description |
|---|---|
| Lot Processing | A lot is processed on the process tools. |
| Setup | Process tool is prepared, or “setup,” for a |
| | different type of processing than it is currently |
| | processing. |
| PM | PM is performed on the process tool. |
| Qual | Stand-alone Qual is performed on the respective |
| | process tool. |
| Machine Batch | Multiple lots are assembled into a batch and |
| | processed simultaneously. |
| Unscheduled | Period in which machine is unexpectedly down, and |
| Downtime | set for anticipated duration. |

The scheduling of an LSA 605 move appointment from, e.g., the port 145 or the process resources 150, 155 in FIG. 1, to a machine port (e.g., the port 145, in FIG. 1) is significantly influenced by the MSA 610 that is scheduled to perform the processing appointment that follows the move appointment. The MSA 610 has a corresponding processing appointment 676 on its calendar. The MSA 610 schedules port reservations in a manner described more fully below. As it schedules a port for the LSA 605, it updates two attributes of the processing appointment. Port assignment and port availability time attributes are updated as a port is scheduled. Scheduling of the port is initially performed when the processing appointment is scheduled, but may be revised subsequently by the MSA 610. The move appointment is scheduled to deliver the lot 130 to the port at the time the port is available. Thus, the MSA 610 influences the scheduling of the move appointments through the management of the ports for the process tool 115.

The scheduling of ports by the MSA 610 is influenced by the machine type of the machine that the MSA 610 represents. A configurable property by machine type specifies the earliest time that a lot 130 can arrive at a port ahead of its processing appointment. For machine types that process lots very quickly, this value may be set to a larger value in order to keep this type of machine fed. For machine types that process lots more slowly, this value may be set to a smaller value in order to enhance scheduling flexibility and not unnecessarily utilize machine ports. In effect, port availability time is configurable anywhere from “just-in-time” for a processing appointment to a significant amount of time prior to the processing appointment. In reaction to these attributes and subsequent revision to these attributes, the LSA 605 schedules/reschedules the move appointment start time and destination location.

In the illustrated embodiment, the LSA 605 creates and utilizes “helper” scheduling class objects to schedule and manipulate different types of appointments. One example of such a helper class object is the MAS 375, first shown in FIG. 3. The MAS 375 is, more particularly, used to schedule and manipulate move appointments and maximum move appointments. A move appointment represents the task of moving or transporting the lot 130—or a vehicle 160 that contains the lot 130—from a specific “source” location to a specific “destination” location. Specific machine ports, WIP stockers, WIP racks, wafer sorters, and under-track storage (“UTS”, sometimes also called “zero-footprint storage”) are examples of locations that may be sources or destinations.

The implementation of the MAS 375 will be dependent on the implementation of the AMHS 138 and its representation in the data store 690. For instance, the AMHS 138 may be interbay or intrabay, which may present different sets of material transports for the MAS 375 by different types of systems as described above. The manner in which the MAS 375 will be implementation specific relative to the implementation of the process flow 100 and the AMHS 138 will be apparent to those skilled in the art having the benefit of this disclosure. For instance, material transports may be categorized as “interbay,” which will be stocker to stocker, or “intrabay,” which will be anything other than stocker to stocker. Interbay and intrabay material transports, accordingly, may be implemented differently. However, not all implementations of an AMHS 138 will include both interbay and intrabay material transports depending on their level of automation. Thus, the implementation of the MAS 375 will also be dependent on the implementation of the AMHS 138.

Move appointments are, from the perspective of the software agents 365, relatively fine-grained in the illustrated embodiment, but alternative implementations may be coarse-grained. For example, if a lot needs to be transported from point A to point C, there is one appointment from point A to point B and another appointment from point B to point C (rather than one appointment from point A to point C). A move appointment may represent either an inter-bay or intra-bay material transport depending on the values of the source and destination locations. If both locations are WIP stockers, the material transport is considered inter-bay; otherwise the material transport is considered intra-bay.

The LSA 605 employs the MAS 375 in at least three types of contexts in the illustrated embodiment. The first is “general scheduling”, in which the scheduling for move appointments and processing appointments occurs under steady state conditions. The second is “initial scheduling,” in which scheduling occurs during initialization of the process flow 100. The third is “reactive scheduling”, in which scheduling occurs in reaction to some event in the process flow 100.

More particularly, when a LSA 605 schedules a lot processing appointment, it utilizes the MAS 375 to schedule move appointments to transport the lot 130 from its current location (or if the current location is in-transit, the destination-if known) to the process tool 115 with which the lot processing appointment has been scheduled. This is referred to herein as “general scheduling.” In essence, the state of the factory is known, and the scheduling proceeds on the basis of that knowledge.

A LSA 605 and various helper scheduling classes also respond to factory state change that affects the lot, to appointment changes initiated by service provider agents and to alarm events (such as alarm events indicating that an appointment has run past its scheduled end time). The MAS 375 is utilized to manipulate move appointments in response to these conditions. This is referred to herein as “reactive” scheduling.

If all or a portion of the process flow 100 goes down for some reason, it is initialized when brought back up. Part of this initialization includes determining the factory state, e.g., where various lots 130 are, what the process tools 115 are currently doing. One or more of the lots 130 may need to be transported, and the appropriate move appointments will need to be scheduled. This is referred to herein as “initial scheduling.”

In the illustrated embodiment, the LSA 605 begins negotiating in a general scheduling session by publishing a bid request 625 to the MSA 610. The MSA 610 for each qualified process tool 115 submits one or more bids 660 to the LSA 605 to process the lot 130. The LSA 605 accepts one of the bids 660. The LSA 605 then confirms the selected bid 660 with a message 665 to the MSA 610. The MSA 610 validates the selected bid 660 with its calendar 670, i.e., ensures that the selected bid 660 can still be implemented. The MSA 610 sees that the slot for the selected bid 660 is still clear, schedules the appointment 675, and sends a bid confirmed message 680 to the LSA 605. The LSA 605 then schedules the appointment 675 on its own calendar 685. When the start time for the scheduled processing appointment arrives, the scheduling agents 605, 610 pass control to respective processing agents, the LPA 695. When one appointment completes, the LSA 605 and MSA 610 start their next appointment if it is time to do so. If it is not time, the LSA 605, MSA 610 set an alarm and wait for the alarm to fire, thereby indicating time to start the next appointment.

Thus, processing appointments, e.g., the processing appointments 675, 676 are booked on calendars, e.g., the calendars 685, 670, maintained by each scheduling agent, e.g., the scheduling agents 605, 610. Whenever the processing appointment 675 is booked, the LSA 605 schedules move appointments for moving the lots 130 to the location of the process tool 115 associated with the newly booked processing appointment 675. For instance, referring to both FIG. 1 and FIG. 6, assume the lots 130 processing on the first process tool 115 exit through a port 140 and need to be deposited at the port 145 of the second process tool 115 for the scheduled processing appointment 675. Each LSA 605 has a respective MAS 375 that it calls for this purpose. The MAS 375 schedules the appointments for the lots 130 to transit between the source and destination locations, e.g., the first and second process tools 115 from port 140 to the port 145.

As will be appreciated by those skilled in the art having the benefit of this disclosure, the process flow 100 will include a number of handling components, only some of which are shown, such as stockers, wafer sorters, under-track storage, and work in progress (“WIP”) racks. For instance, FIG. 1 depicts three process resources 150, 155a, 155b. The MAS 375 determines the appropriate material transports required in order for the lot 130 to meet a confirmed processing appointment 675 or, if needed, a preceding carrier-in appointment associated with the processing appointment 675.

To do this, the MAS 375 obtains the current (if the processing appointment is the next appointment) or projected (if the processing appointment is more than one process operation ahead) location of the lot 130 from a data store 690, which is a part of the computing system 125, shown in FIG. 1. The data store 690 may be of any suitable structure known to the art, and may actually include several data structures (not shown). The data store 690 is used to store a wide variety of information that may be used in the automated control of the factory, including:
associations among various pieces of equipment, e.g., the association of the nearest stocker to a process tool;
the duration of certain events in the fab, e.g., the duration of process-operations that might be scheduled or the duration of material transports from one location to another;
the location of certain manufacturing domain entities, e.g., the locations of lots or mobile resources; and
the states of the factory.
   Thus, the data store 690 contains data indicating the definition and state of the AMHS 138 and the status of the factory as a whole.

The data store 690 consequently includes information such as the current location of a carrier (not shown) containing the lot 130. The data store 690 also contains data indicating relationship of various process stations 105 through the AMHS 138, such that the material transports necessary to reach one point in the process flow 100 from another can be determined. Based on the source location, the destination location, and the start time of the appointment, the MAS 375 determines the appropriate material transports and schedules move appointments on the calendar 685 of the LSA 605.

In the illustrated embodiment, the MAS 375 schedules the move appointment(s) “just in time.” The LSA 605 typically calls the MAS 375 as a present processing appointment nears completion. The LSA 605 schedules ahead a “next” processing appointment 675 as described above and the MAS 375 schedules the material transports needed to make this next processing appointment 675 (or, if needed, a carrier-in appointment associated with the next processing appointment 675).

The MAS 375 schedules a material transport to begin immediately, or at least as soon as is reasonably practicable, after the current processing appointment completes to get the processed lot 130 off the port 140. It is desirable to transport the lot 130 off the port 140 of the process tool 115 as soon as processing is complete to enable other lots 130 to utilize the port 140 of the processing tool 115 without delay. Note that, in the case of buffer process tools 115 that need unloading, the MAS 375 schedules the material transport to begin after the carrier-out appointment, as opposed to processing appointment, completes.

However, in some circumstances, the remainder of the material transports to the destination location may be delayed to avoid spurious transports that may be negated by subsequent events. For instance, the processing appointment associated with the move appointment may be canceled, in which case it may be undesirable to start the material transport at the earliest possible time. Delay may also be desirable to preserve flexibility in port assignments, e.g., in the event a higher priority lot needs a port quickly. Still further, a port may be busy, and so a delay to wait for the port to clear may be desirable.

Note that, as alluded to above, some types of process tools 115 require “loading” and “unloading.” These processes are also called “carrier-in” and “carrier-out”. That is, the lots 130 will need to be loaded onto the process tool 115 when they arrive and prior to processing. Typically, they will also need to be unloaded after processing is completed. The MAS 375 in this circumstance therefore schedules material transports so that the lots 130 arrive at the process tool 115 “just in time” to be loaded prior to processing. Carrier-in and carrier-out appointments are returned along with a processing appointment in the bid confirmation message 665 from an MSA 610 to the LSA 605. Prior to the MSA 610 returning these appointments, the MSA 610 may need to negotiate with a RSA (not shown) representing a tool loading resource. These negotiations are conducted similar to the manner described in FIG. 6 above between the LSA 605 and the MSA 610.

Thus, in the negotiations between the LSA 605 and the MSA 610, the MSA 610 includes not only the processing appointment 675, but also any associated carrier-in/carrier-out appointments that may be needed. The LSA 605 and the RSA actually schedule carrier-in/carrier-out appointments (not shown) for the lot 130 and the tool loading resource (also not shown), respectively, on their respective calendars. Thus, if the process tool 115 requires loading, the MAS 375 schedules move appointments for the lot 130 to arrive in time for loading rather than processing.

The granularity of the move appointments in this particular embodiment is relatively fine. For instance, depending on the implementation, the material transport from the first process tool 115 in FIG. 1 to the second process tool 115 might include material transports from the port 140 to a source stocker 155a nearest the first process tool 115, from the source stocker 155a to a destination stocker 155b, and from the destination stocker 155b to the port 145 of the second process tool 115. Note that the source and destination stockers 155a, 155b will typically be the nearest available stocker to the source and destination locations, respectively, as determined from the information in the data store 690. In the illustrated embodiment, however, move appointments are scheduled from the source location (e.g., the port 140) to the destination location (e.g., the port 145) or to a process resource (e.g., an under-track storage) nearest to the destination location. Whether the move appointment is directly to the destination location or the process resource nearest the destination will depend on a number of implementation specific factors such as time (e.g., current time, next processing appointment start time), transport duration, and port availability.

In this context, the port 140 may be considered a “source location” and the port 145 a “destination location” from and to which the lots 130 need to be transported to meet a booked processing appointment. The source location and destination location may be any component of the AMHS 138 or process flow 100. Thus, instead of the process tool ports 140, 145, there might be any number of handling components not shown, such as stockers, wafer sorters, under-track storage, and work in progress (“WIP”) racks, for example. This level of granularity renders any given implementation of the MAS 375 dependent on the description of the AMHS 138 in the data store 690.

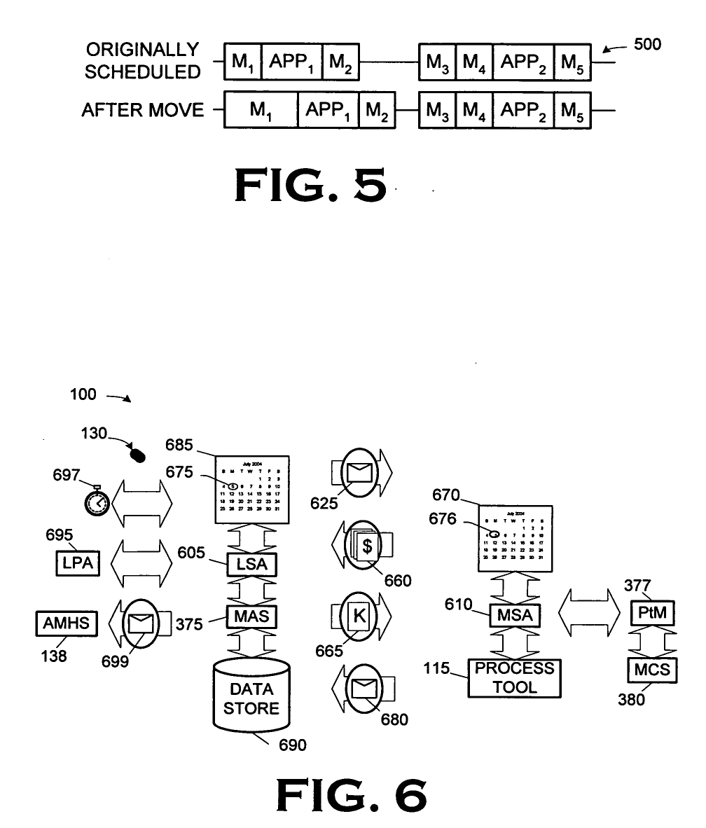

Once the material transport is scheduled (at 203, FIG. 2), the LSA 605 requests (at 206, FIG. 2) a staging of a vehicle, e.g., the vehicle 160, in FIG. 1, for the material transport a predetermined time period prior thereto. Assume the appointment APP₁ in the calendar 500, shown in FIG. 5, is currently actively processing on the first process tool 115, shown in FIG. 1. The appointment APP₁ has a scheduled end time, which provides some assurance as to what time the represented process operation will end. As shown, the subsequent move appointment M₂ is scheduled to begin at the same time the appointment APP₁ is scheduled to end to get the finished lot 130 off the port 140, also shown in FIG. 1.

When the appointment APP₁ is booked, the LSA 605 sets an alarm 697 for the predetermined time period prior to the end of the processing appointment APP₁. Note that the end of the processing appointment APP₁ is the same as the beginning of the move appointment M₂. The predetermined time period is defined in the illustrated embodiment in traditional measures of time, i.e., minutes and seconds. The predetermined time is calculated or retrieved from a factory metrics residing in the data store 690. In some embodiments, one metric residing in the data store 690 is the estimated time it takes to stage a vehicle 160 to each of a plurality of given points in the process flow 100.

Note that the metric residing in the storage 690 may not be the actual measure of the predetermined time. For example, assume that the metric is a measure of the time it takes to stage a vehicle 160 to a particular destination process tool 115 in a process flow 100. If a given embodiment stages a vehicle 160 to arrive just in time for a scheduled material transport, then the predetermined time is set to the retrieved metric. However, some embodiments may wish to stage the vehicle 160 to arrive at a time prior to the commencement of the material transport. Assume an embodiment wishes for a vehicle 160 to be waiting 35 seconds for the commencement of the material transport. Then, the predetermined time is set to the retrieved metric+35 seconds.

Note that some embodiments may define the predetermined time period in less traditional measures. For instance, the illustrated embodiment assigns a variety of “states” to appointments. A processing appointment such as the appointment APP₁ includes a transition from an “active” state to a “near complete” state. For example, a 15 minute process operation transitions to “active” when it begins and might transition to “near complete” at the 13 minute mark of the operation. The transition point will be a function of the process operation. However, for present purposes, the predetermined time period might be defined as the time at which the process operation transitions from “active” to “near complete.”

When the alarm 697 fires, it prompts the LSA 605 to initiate the move appointment M₂. The LSA 605 sends a message 699 to the AMHS 138 to notify the AMHS 138 of the time at which the move appointment M₂ will begin. The message 699 requesting the move includes not only the start time for the move appointment, but also an identification of the material to be moved, the source location for the transport and the destination location for the transport. Upon receiving the message 699, the AMHS 138 stages the vehicle 160. Thus, the message 699 sent at the predetermined time period as described above also functions as a request to stage the vehicle 160. Stated alternatively, the AMHS 138 infers the staging request from the message 699 and the message 699 constitutes an implied request to stage the vehicle 160.

Thus, in this embodiment, the LSA 605 requests the staging of the vehicle (at 206, in FIG. 2) by notifying the AMHS 138 through the message 699 to initiate the material transport. This particular embodiment therefore considers the staging of the vehicle (at 206, in FIG. 2) to be a part of the material transport. Note, however, that the invention is not so limited. In alternative embodiments, the LSA 605 may, for example, set an alarm solely for the purpose of sending an express request (not shown) for the staging of the vehicle (at 206, in FIG. 2). This may, in turn, be construed by the AMHS 138 to be a notification to initiate the material transport. Or, alternatively, the LSA 605 may send the message 699 notifying the AMHS 138 to request the staging (at 206, in FIG. 2) and a separate request (not shown) to initiate the material transport. Note that, in either of the latter two scenarios, the time for staging the vehicle (at 206, in FIG. 2) may be consonant with the time at which the alarm 697 is fired. That is, the LSA 605 may set the alarm 697 to fire the predetermined time period before the material transport is scheduled to occur.

As mentioned above, the illustrated embodiment stages the vehicle (at 206, in FIG. 2) to arrive “just-in-time” for the material transport, so that the vehicle is waiting when the lot 130 is ready for the actual transport. Alternative embodiments may provide an extra margin in the timing so that the vehicle arrives for the actual transport and waits for the lot 130. Such a margin may be desirable to offset unanticipated delays during the staging. Also, where a lot 130 is subjected to a maximum queue time for the next process operation, the extra margin may be desirable to help prevent maximum queue time violations. The material transport can then be executed in conventional fashion.

In the illustrated embodiment, scheduling appointments includes managing booked appointments. As previously mentioned, the LSA 605 also calls the MAS 375 for “reactive scheduling.” Booked appointments are subject to modification to accommodate the scheduling of new appointments and to adjust to unexpected developments, and the MAS 375 reacts to these events accordingly. Booked processing appointments may be shifted, bumped, canceled, and re-scheduled. Some events causing these things to happen are unexpected. A wafer-based machine, for instance, may go down without having been scheduled to do so. This process tool 115 might break down in the middle of processing a plurality of wafers 130, leaving some of them processed, some of them unprocessed, and all of them on the process tool 115. The MAS 375 for the lot 130 must be able to schedule appropriate material transports upon invocation by the respective LSAs 605.

As another example, booked processing appointments may be shifted, which may cause booked move appointments to be shifted. As was mentioned above, each processing appointment includes a “commitment window.” The commitment window provides the MSA 610 with flexibility that in turn permits the MSA 610 to “optimize” the schedule in reaction to changes in the state of the factory or in various appointments. Processing appointments are viewed as “beads on a string”. Existing processing appointments are permitted to slide later or earlier in time within their respective commitment windows as necessary to create a more efficient schedule. In the illustrated embodiment, to simplify the logic, appointments are not permitted to shift past the next appointment in either direction.

For instance, a processing appointment may shift earlier in time within its commitment window if a previous processing appointment completes early. Similarly, a processing appointment might be shifted later in time if the previous processing appointment runs too long. In either situation, the LSAs 605 for the affected lots 130 are notified by the MSAs 610 that the booked processing appointment has been changed. The difference in start times and end times for the booked processing appointment may change the appropriateness of scheduled material transports. For instance, if a booked processing appointment is moved to an earlier start time, the lot 130 must arrive earlier than may be provided for by the currently scheduled material transports. Conversely, a later start time means the lot 130 should transport later. In either circumstance, different material transports may be appropriate to achieve the correct arrival time for the lot 130. In these situations, the move appointments may be shifted responsive to the shift in the associated processing appointment. Note that multiple move appointments may be scheduled for a lot 130 to reach its destination location. Consequently, there may be several move appointments to shift in some circumstances.

The LSA 605, upon receiving the appointment state change, among other things, calls the MAS 375 and passes it the new information for the changed processing appointment. The MAS 375 retrieves the current location for the lot 130 from the data store 690, if the processing appointment being changed is the next processing appointment. If the processing appointment being changed is one or more process operations in the future, then the MAS 375 retrieves the projected location of the lot 130 prior to the preceding move appointment(s). This retrieval includes, for instance, retrieval of the destination and arrival time for any active move appointment. The MAS 375 reviews the calendar 385 for the LSA 605 to determine what move appointments are booked and which of the booked appointments are active. The MAS 375 then acts depending on whether any move appointments are active and, if any are active, whether the move has begun.

Assuming a change needs to be made, if the booked move appointment is inactive, the MAS 375 can shift it or cancel it and schedule another. If the booked move appointment is active, but the material transport itself has not yet begun, the booked move appointment can be canceled, and a new, more appropriate move appointment scheduled. If the booked move appointment is active and the material transport itself has actually begun, the LSA 605 can take one of several approaches. The LSA 605 may wait for the material transport in the active move appointment to finish and then book new move appointments to the new destination at the new processing appointment start time. Or, the LSA 605 can modify the current move appointment by notifying the AMHS 138 of the new destination and new arrival time. Or, the LSA 605 can notify the AMHS 138 to abort the current move appointment in mid-stream and then book new appointments to the new destination by the new processing appointment start time. To some degree, the choice among these kinds of options will depend on the capabilities of the particular implementation of the AMHS 138.

Appointments are also commonly changed when their duration, or the duration of an appointment immediately preceding it, is longer than expected. When appointments made by the LSA 605 and MSA 610 become active, the LSA 605 and MSA 610 set “alarms” (not shown) that notify them when the appointment is scheduled to be completed. When the task is completed, the scheduling agents 605, 610 are notified and these alarms are turned off. If the alarm goes off, then the scheduling agents 605, 610 know the appointment did not complete timely, and that accommodations need to be made in the schedule. FIG. 5 illustrates one such situation. More particularly, in FIG. 5, the move appointment M₁ had a longer duration than was expected, and so the move appointment M₂ and the appointment APP₁ were shifted later in time to accommodate this longer duration. In either case, the longer than expected duration means the LSA 605 calls the MAS 375 to expand the move appointment M₁. If necessary, then the MAS 375 begins shifting, canceling, and rescheduling other move appointments.

As alluded to immediately above, booked appointments may be completely canceled. A LSA 605 may receive a state change message from a MSA 610 indicating that a processing appointment has been canceled, for instance, if the process tool 115 is no longer able to meet the booked appointment within the scheduled commitment window. When the LSA 605 receives the state change message, it will remove the canceled appointment from its calendar 685 and begin rescheduling. The MAS 375 also removes associated move appointments and begins its role in the rescheduling of the canceled processing appointment.

Note that, as booked appointments are shifted, canceled, and rescheduled, the changes can ripple through the process flow and, in particular, the calendars. Changes are instituted by a single software agent 365, but a changed appointment may be booked on multiple calendars, depending on the appointment type. For instance, in the illustrated embodiment, a processing appointment 675 is booked on both the calendar 685 maintained by the LSA 605 and the calendar 670 maintained by the MSA 610. However, move appointments will appear only on the calendar 685 maintained by the LSA 605. For appointments booked on multiple calendars, the changes must consequently be communicated to the other software agents so they can update their calendars respectively. This is true also of other types of events in the process flow.

To this end, the software agents employ additional software components (not shown) known as “notifiers” and “listeners.” The software agents employ listeners to track events in the process flow that can affect their scheduling. The listeners “subscribe” to topics, or events in the factory. Notifiers “publish” events when changes occur within the factory. Listeners, in turn, notify each subscribing software agent 365 when an event of interest is published by a notifier. The identity of the selected events is implementation specific, but appointment changes 365 are one obvious example that will be employed in most embodiments. The various software agents 365 can then keep their calendars updated as changes are instituted by other software agents 365. The data store 690 also employs a number of listeners to keep informed as to events in the factory that change the state thereof. The notifiers and listeners therefore also update the data store 690, so that the state of the factory and factory control systems is accurately reflected when the MAS 375 accesses it to determine the location and appropriate material transports for a lot 130 that needs to be transported.

In addition to the utility of the notifiers and listeners in “reactive scheduling,” the ability of the data store 690 to keep and update the state of the factory through the notifiers and listeners is particularly useful in “initial scheduling.” When the process flow 100 is brought up after being down, the software agents 365 need to orient themselves, determine where their manufacturing domain entity is (if applicable), the state of their manufacturing domain entity, and what they need to schedule. All of this information is kept in the data store 690, and is kept up to date by the network of notifiers and listeners described immediately above. The LSA 605, for instance, can access the data store 690 to determine where in the process flow its lot 130 is. During initial scheduling, the LSA 605 discovers whether some activity was in progress and schedules appointments needed for that activity to complete. If the lot 130 needs to be transported, the LSA 605 may call the MAS 375 to schedule the desired material transports as discussed above for general scheduling. If the lot 130 was in transit during the initialization, the MAS 375 can schedule the move that is underway so that it can complete.

The foregoing discussion pertains to the scheduling capabilities of the software agents 365. In addition to scheduling, the software agents 365 also initiate the execution of scheduled activities. For example, as a scheduled task is being executed, the scheduling agent, e.g., the LSA 605 and/or the MSA 610, subscribes to and monitors factory state change events. In addition, the scheduling agent monitors appointment state change events due to the fact that an agent with a corresponding appointment may actually be responsible for initiating appointment state change. This monitoring is performed through the web of notifiers and listeners described above that are also used in scheduling. One example illustrating how appointments are activated, how progress is monitored, how appointment states are transitioned and how processing is initiated for the scheduled task is presented below.

For example, if a processing appointment is being executed, the LSA 605 transitions appointment states by receiving appointment state changes initiated by the MSA 610. The MSA 610 monitors factory state change events (i.e., events indicating that processing has started or completed) in order to transition the appointment states. When the scheduling agent detects that the scheduled task has been completed, the scheduling agent will update the state of the associated appointment in the agent's calendar and perform other functions. In the current example, the LSA 605 receives an appointment state change event indicating that the processing appointment has been completed and will update the state of its corresponding processing appointment to “completed.”

Next, the scheduling agent identifies the next appointment scheduled in its calendar. For example, the LSA 605 should have a move appointment scheduled immediately after the processing appointment. Assume the move appointment in this example has a source location of a tool port 140 of the process tool 115 performing the processing on the lot 130 and has a destination location of the process resource 150 nearest the port 145 of the process tool 115 for the next processing appointment. Note that the association of the process resource 150 to the second process tool 115 is stored in the data store 690, and thus can be readily ascertained by the LSA 605 and others.

The scheduling agent will obtain the start time of the next appointment. If the start time of the next appointment has arrived, the scheduling agent will perform a number of functions (described below) including initiating the appointment. In our example, the time for the next move appointment has arrived. Accordingly, the MAS 375 will change the move appointment's state to “active” and will notify its respective lot processing agent (“LPA”) 695 to initiate processing of the task associated with the move appointment. The MAS 375, on behalf of the LSA 605, also requests the staging of a vehicle (at 206, FIG. 2) for the move appointment in accordance with the invention, as was described above, prior to the move appointment start time. In this example, the LPA 695 will call on the AMHS 138 with the proper command for initiating the appropriate transport.

The LSA 605 will next construct an alarm (“end time alarm”) to be fired at the scheduled end time of the move appointment. This alarm will be added to the system's alarm clock (not shown) to indicate when the material transport should be completed. The LSA 605 utilizes subscribers to monitor factory state change events as discussed above. In the case of monitoring move appointments, change in a lot's location indicates progress of the material transport task that has been scheduled. Initially, the LSA 605 should receive a factory change event indicating that the lot's location has changed from the tool port 140 to an in transit location. This change is initiated by the AMHS 138 (or a WFT 165) removing the carrier (not shown) containing the lot 130 from the tool port 140. At this point, the LSA 605 calls on the MAS 375 to transition the move appointment from an active state to a “processing” state, indicating the material transport is in progress. The corresponding LPA 695 is notified in case tasks associated with this state change require actions to be initiated.

Subsequently, the LSA 605 should receive a factory change event indicating that the lot's location has changed from an in transit location to the location of the process resource 150 nearest the process tool 115 that processed the lot 130. This change event initiates from the AMHS 138 when it detects a carrier has arrived at the WIP stocker's input port (not shown). At this point, the MAS 375 transitions the move appointment from a “processing” state to a “completed” state as the lot 135 has arrived at its destination location. In addition, the LPA 695 is notified in case processing should be performed as a result of this event and the end time alarm (set earlier) is removed as the material transport completed earlier than scheduled.

With the completion of the move appointment, the LSA 605 will attempt to find the next appointment on its calendar 685. Assume a move appointment is the next appointment. The source location for this appointment is the process resource 150 location and the destination location is the WIP stocker 155 nearest the process tool 115 that will perform a subsequent processing appointment. In this example, the start time of this move appointment is in the future. As a result, the LSA 605 will construct an alarm (“start time alarm”) to be fired at the time for initiating the move appointment. Note that the alarm is set for a time that is actually prior to the scheduled move appointment start time. This alarm is added to the system's alarm clock.

When the alarm fires, the alarm will callback on the LSA 605. The LSA 605 will, among other things, call on the MAS 375 to change the move appointment's state to “active”. In addition, the LSA 605 will notify its respective LPA 695 to initiate processing of the appointment. The LPA 695 will send appropriate commands to the AMHS 138 to initiate movement of the carrier in which the wafer 130 is handled, including the use of the method 200, in FIG. 2, in accordance with the present invention. The LSA 605 will also construct an end time alarm. Subsequently, the LSA 605 receives a factory change event indicating that the lot's location has changed from the source process resource 150 to an in transit location. This event results from the AMHS 138 detecting the carrier for the lot leaving the process resource 150.

The LSA 605 will call on the MAS 375 to change the move appointment from an “active” state to a “processing state” and will call on the LPA 695 in case processing is required at this stage. Assume the end time alarm fires prior to the LSA 605 receiving a subsequent lot location change event. This indicates that the move appointment is running over the scheduled duration in a situation analogous to that shown in FIG. 5. The MAS 375 will calculate a new end time for the appointment, shift subsequent appointments later in time if called for, modify the move appointment's end time and set a new end time alarm to reflect the expanded move appointment.

Subsequently, the LSA 605 receives a factory change event indicating that the lot's location has changed from in transit to the destination WIP stocker 155. This event results from the AMHS 138 detecting the carrier arriving at the input port (not shown) of the destination WIP stocker 155. The MAS 375 will transition the move appointment to a “completed” state and initiate the LPA 695 for potential processing. This cycle is repeated in reaction to factory state changes, alarms firing, and appointment state changes for subsequent scheduled appointments.

One aspect of the present invention not previously discussed is port management. Referring now to FIG. 1, the lots 130 enter and exit the process tools 115 through ports, e.g., the ports 140, 145, as was alluded to above. The MSA 610, shown in FIG. 6, calls on a helper-class object called a “port manager” (“PtM”) 377, shown in both FIG. 3 and FIG. 6, to help manage its ports. The PtM 377, among other things, tracks the use and availability of ports for the respective process tool 115. The PtM 377 also provides this information to the MSA 610 during the scheduling process described above. In this manner, the MSA 610 generally sets ports as destinations and port availability times to which the LSA 605 reacts. Thus, move appointments (e.g., the move appointments M₁-M₆, shown in FIG. 4) can be scheduled for the lots 130 to be moved onto and off individual ports 140, 145, shown in FIG. 1.

It is through this port management that the MSA 610 influences the scheduling of the LSA 605. More particularly, the PtM 377 determines when a particular port is available. The MSA 610 gets this information from the PtM 377 and builds it into the bids 660 that it submits to the LSA 605 during the bidding process discussed relative to FIG. 6. Thus, each bid 660 includes a port assignment and a port availability time that are determined by the PtM 377. When the LSA 605 accepts the bid 660, it also schedules through the MAS 375 the move appointments needed to get the lot 130 to the assigned port at the time it is available, or as close as is possible to that time. Consequently, although the MAS 375 does not schedule on behalf of the lot 130, it strongly influences scheduling on behalf of the lot 130 through the operation of the PtM 377.

The scheduled move appointments are initiated and executed by a part of the AMHS 138 known as the Material Control System (“MCS”) 380, shown in both FIG. 3 and FIG. 6. In prior implementations, the MCS 380 executes one move at a time relative to a port without regard to what other moves have been scheduled or are in progress. Thus, on some occasions, problems arise because a port is occupied or otherwise not available when a move to the port is being executed.

For instance, a problem sometimes arises when the MCS 380 executes a move for one lot 130 to a port before executing a move for another lot 130 off the port because the port is still occupied. The MCS 380 does not consider the order in which the two moves are executed. The MCS 380 only executes whichever move appointment is next without regard to whether one interferes with the other. If this occurs, the MCS 380 can be instructed to, for instance, loop around one time to see if the port becomes available or to transport the lot 130 to an UTS. Either way, the associated processing appointment may be delayed or canceled, which can affect other scheduled appointments and increase the level of scheduling activity needed to process the lots 130.

The occurrence of these occasions can be lessened by imposing some minimum delay between scheduled moves related to a particular port. This delay can be imposed during scheduling of the move appointments described above, since bids for processing appointments, processing appointments, and move appointments include port and port available time attributes. The delay should be of sufficient duration that the move off the port can make the port available for the move onto the port. While such a delay may be relatively small for any given instance, the accumulated delay in the process flow might be quite significant.

The illustrated embodiments may employ one or several mechanisms to deal with these situations. First, the MCS 380 may track the “order” of moves for a given port so that the moves off the port are performed prior to moves onto the port. Second, a dynamic reallocation can be made if a port is full to another one if there is an available port. The dynamic reallocation can be made by the port manager 377 and signaled to the AMHS 138. Or, the AMHS 138, upon realizing the assigned port is full, can call the port manager 377 through the MSA 610 to identify an available port and then signal the reallocation to the port manager 377. The AMHS 138 is capable of determining whether a port is available by accessing the data store 690, shown in FIG. 6, which contains the state of the factory. Or, the AMHS 138 and the port manager 377 can interact in some other way to dynamically reallocate the port assignment to an available port. Should the dynamic reallocation fail for lack of an available port, then the MCS 380 can be instructed to, for instance, loop around one time to see if the port becomes available or to transport the lot 130 to an UTS.

In the illustrated embodiment, the invention is implemented using object oriented programming (“OOP”) techniques, although the invention may be implemented using techniques that are not object oriented. The software agents 365 are implemented as objects and are intelligent, state aware, and are imbued with specific goals for which they autonomously initiate behaviors to achieve. Their behavior may be script-based or rules-based. The behavior is designed to achieve selected goals such as achieving an assigned lot due date, achieving a predefined level of quality, maximizing machine utilization, and scheduling opportunistic preventive maintenance. The MAS 0.375 is also implemented as an object, but of a different class—called a “helper” class. The helper class is a class of objects to which various objects that are software agents 365 delegate various responsibilities or that provide some useful service in the process flow 100. Notifiers and listeners, mentioned above, are also helper class objects.

Because the illustrated embodiment is implemented in an OOP environment, the MAS 375 implements the scheduling functionality through calls to various “methods.” The MAS 375 calls different methods depending on whether it is being called for general scheduling, reactive scheduling, or initial scheduling. However, the invention is not so limited to this implementation. The functionality attributed to the MAS 375 might be incorporated into the LSA 605 in alternative embodiments instead of being delegated to a helper object. Indeed, the functionality may be implemented using techniques alternative to OOP. The invention is not limited by this aspect of the implementation.

Thus, as is apparent from the discussion above, some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

However, as will be apparent to those skilled in the art having the benefit of this disclosure, not all software components of the system described above necessarily can communicate directly with one another. For instance, the software agents 365, the factory control systems (e.g., the AMHS 138), and the process tools 115 may not be able to communicate directly with each other. This is not an uncommon occurrence in systems of this type. Accordingly, various embodiments of the invention typically will employ interpreters, adapters, and interfaces in accordance with conventional practice to facilitate such communications. For instance, in the illustrated embodiment, communications with the AMHS are conducted through an AMHS adapter and communications with the process tools 115 are conducted through “equipment interfaces.” These are software implemented, and perform as a “translator” from the language of one software component into that of another.

Note that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

As will become apparent to those in the art having the benefit of this disclosure, the present invention in its various aspects and embodiments will provide a number of advantages over the state of the art. For instance, in some embodiments, a move may be initiated at a desired start time even if the destination is currently occupied because the port will be available at the time the move is completed. Conventional systems wait until the destination is cleared before initiating a move, or even staging a vehicle. In OOP implemented embodiments, the predetermined time at which the staging request is sent prior to the move can be externally configured by, e.g., machine type, etc. Furthermore, port availability relative to a processing appointment can be externally configured. For instance, the port availability for a process tool 115 that processes lots 130 very quickly may be externally configured so that there is only a short time between port availability and the start of the processing appointment. Conversely, a process tool 115 that processes lots 130 slowly may have a relatively longer period between port availability and the start time of the processing appointment. Some embodiments of the present invention will also provide greater flexibility in port assignment. In general, these types of advantages and benefits decrease, overall, processing delays where the invention is implemented.

The present invention admits wide variation not only in implementation, but also in application. For instance, the material may be something other than lots, e.g., a process resource such as a reticle. Wafer fabrication process flows normally includes process tools that employ reticles that are shared by several process tools at a time. A reticle management system controls the use, location, and management of the reticles, and may employ the present invention in doing so. However, an AMHS manages many types of process resources such as dummy wafers, carriers, etc. whose transport may employ the present invention. Indeed, as alluded to above, the present invention may even be employed in process flows that produce thing other than semiconducting wafers.

This concludes the detailed description. The particular embodiments disclosed above are illustrative only, as the invention may be modified and practiced in different but equivalent manners apparent to those skilled in the art having the benefit of the teachings herein. Note that further variations not discussed may be employed in still other embodiments. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for use in scheduling in an automated process flow, the method comprising:
scheduling a material transport in the process flow; and
requesting a staging of a vehicle for the material transport a predetermined time period prior to the material transport.

2. The method of claim 1, wherein scheduling the material transport includes scheduling ahead an appointment for the material transport.

3. The method of claim 1, wherein scheduling the material transport includes scheduling one of a material transport from a first process tool to a first process resource, from the first process resource to a second process tool, from the first process resource to a second process resource, from a second process resource to a second process tool, and from the first process tool to the second process tool.

4. The method of claim 3, wherein at least one of the first process resource and the second process resource comprises one of a work-in-progress stocker, a wafer sorter, a work-in-progress rack, and an undertrack storage.

5. The method of claim 1, wherein scheduling the material transport for a material includes scheduling the material transport for a lot of silicon-based wafers or for a reticle.

6. The method of claim 4, wherein at least one of the first process tool and the second process tool is one of a fabrication tool and a metrology tool.

7. The method of claim 1, wherein scheduling the material transport includes setting an alarm for requesting the material transport.

8. The method of claim 1, wherein requesting the staging includes notifying an automated material handling system of the start time for material transport.

9. The method of claim 1, wherein scheduling the material transport includes modifying an appointment for the material transport responsive to conditions in the process flow.

10. The method of claim 9, wherein modifying the appointment includes shifting the material transport earlier in time, shifting the material transport later in time, expanding the time for the appointment, shrinking the time for the appointment, modifying the appointment with one of a new destination or arrival time during the appointment, aborting the appointment and scheduling a new appointment, and canceling and re-scheduling the appointment.

11. The method of claim 1, further comprising executing the scheduled material transport.

12. The method of claim 11, wherein executing the material transport includes dynamically reallocating a port assignment for the destination.

13. The method of claim 1, further comprising scheduling a processing operation for the material.

14. The method of claim 1, wherein scheduling the material transport includes a software scheduling agent representing the material calling a software implemented move appointment scheduler.

15. The method of claim 1, wherein scheduling the material transport includes scheduling the material transport in one of initial scheduling, general scheduling, and reactive scheduling.

16. The method of claim 1, wherein staging the vehicle for the material transport the predetermined time period prior to the material transport includes staging the vehicle to arrive for the material transport just in time for the material transport.

17. The method of claim 1, wherein staging the vehicle for the material transport the predetermined time period prior to the material transport includes staging the vehicle to arrive for the material transport in time to wait therefore.

18. The method of claim 1, wherein requesting the staging includes impliedly requesting the staging.

19. The method of claim 1, wherein requesting the staging includes expressly requesting the staging.

20. The method of claim 1, further comprising tracking the order of material transports so that a first material may be transferred off a port prior to transporting a second material onto the port.

21. The method of claim 1, wherein scheduling the material transport includes scheduling a delivery to a port of a process tool assigned by the process tool.

22. The method of claim 21, wherein scheduling the delivery to the port includes scheduling the delivery to the port at a time assigned by the process tool.

23. The method of claim 21, wherein the port is assigned by the process tool through a machine scheduling agent.

24. The method of claim 23, wherein assigning the port includes calling a port manager.

25. The method of claim 1, wherein scheduling the material transport includes scheduling the delivery to the port at a time assigned by the process tool.

26. The method of claim 1, wherein scheduling the material transport is influenced by the destination of the transport.

27. The method of claim 26, wherein scheduling the material transport includes scheduling a delivery to a port of a process tool assigned by the process tool.

28. The method of claim 27, wherein scheduling the delivery to the port includes scheduling the delivery to the port at a time assigned by the process tool.

29. The method of claim 26, wherein scheduling the material transport includes scheduling the delivery to the port at a time assigned by the process tool.

30. A program storage medium encoded with instructions that, when executed by a computing device, performs method for use in scheduling in an automated process flow, the encoded method comprising:
scheduling a material transport in the process flow; and
requesting a staging of a vehicle for the material transport a predetermined time period prior to the material transport.

31. The program storage medium of claim 30, wherein scheduling the material transport in the encoded method includes scheduling one of a material transport from a first process tool to a first process resource, from the first process resource to a second process tool, from the first process resource to a second process resource, from a second process resource to a second process tool, and from the first process tool to the second process tool.

32. The program storage medium of claim 30, wherein requesting the staging in the encoded method includes notifying an automated material handling system of the start time for material transport.

33. The program storage medium of claim 30, wherein scheduling the material transport in the encoded method includes modifying an appointment for the material transport responsive to conditions in the process flow.

34. The program storage medium of claim 30, wherein staging the vehicle for the material transport the predetermined time period prior to the material transport in the encoded method includes staging the vehicle to arrive for the material transport just in time for the material transport.

35. The program storage medium of claim 30, wherein staging the vehicle for the material transport the predetermined time period prior to the material transport in the encoded method includes staging the vehicle to arrive for the material transport in time to wait therefore.

36. The program storage medium of claim 30, wherein requesting the staging in the encoded method includes impliedly requesting the staging.

37. The program storage medium of claim 30, wherein requesting the staging in the encoded method includes expressly requesting the staging.

38. A computing system, comprising:
a computing device;
a bus system;
a storage communicating with the processor over the bus system; and
a software application residing on the storage that, when invoked by the computing device, performs a method for use in scheduling in an automated process flow, the method comprising:
scheduling a material transport in the process flow; and
requesting a staging of a vehicle for the material transport a predetermined time period prior to the material transport.

39. The computing system of claim 38, wherein scheduling the material transport in the method includes scheduling one of a material transport from a first process tool to a first process resource, from the first process resource to a second process tool, from the first process resource to a second process resource, from a second process resource to a second process tool, and from the first process tool to the second process tool.

40. The computing system of claim 38, wherein requesting the staging in the method includes notifying an automated material handling system of the start time for material transport.

41. The computing system of claim 38, wherein scheduling the material transport in the method includes modifying an appointment for the material transport responsive to conditions in the process flow.

42. The computing system of claim 38, wherein staging the vehicle for the material transport the predetermined time period prior to the material transport in the method includes staging the vehicle to arrive for the material transport just in time for the material transport.

43. The computing system of claim 38, wherein staging the vehicle for the material transport the predetermined time period prior to the material transport in the method includes staging the vehicle to arrive for the material transport in time to wait therefore.

44. The computing system of claim 38, wherein requesting the staging in the method includes impliedly requesting the staging.

45. The computing system of claim 38, wherein requesting the staging in the method includes expressly requesting the staging.

46. A method for use in scheduling in an automated process flow, the method comprising:
scheduling on behalf of a first portion of a plurality of manufacturing domain entities for the consumption of processing services provided by a second portion of the manufacturing domain entities; and
influencing the scheduling through the management of the second portion of the manufacturing domain entities.

47. The method of claim 46, wherein scheduling on behalf of the first portion includes at least one of scheduling a material transport and scheduling a process operation.

48. The method of claim 46, wherein scheduling on behalf of the first portion includes scheduling on behalf of a lot of silicon-based wafers or for a reticle.

49. The method of claim 46, wherein scheduling for the consumption of processing services provided by the second portion of the manufacturing domain entities includes scheduling for the consumption of processing services provided by at least one of a reticle and a process tool.

50. The method of claim 46, wherein scheduling for the consumption of processing services includes modifying an appointment for the consumption responsive to conditions in the process flow.

51. The method of claim 46, further comprising executing the scheduled consumption of process services.

52. The method of claim 51, wherein executing the scheduled consumption of process services includes dynamically reallocating a port assignment for the destination of a material transport.

53. The method of claim 51, wherein executing the scheduled consumption includes requesting a staging of a vehicle for a scheduled material transport a predetermined time period prior to the material transport.

54. The method of claim 51, wherein executing the scheduled consumption of process services includes tracking the order of material transports so that a first material may be transferred off a port prior to transporting a second material onto the port.

55. The method of claim 46, wherein scheduling the consumption includes a software scheduling agent representing a manufacturing domain entity calling a software implemented move appointment scheduler.

56. The method of claim 46, wherein scheduling the consumption includes scheduling the consumption in one of initial scheduling, general scheduling, and reactive scheduling.

57. The method of claim 46, wherein influencing the scheduling includes:
determining a port assignment and a port availability time for a proposed material transport; and
providing the port assignment and the port availability time for use in the scheduling.

58. The method of claim 57, wherein scheduling the consumption includes scheduling a material transport with a delivery to a port identified in the port assignment at the port availability time.

59. The method of claim 46, wherein influencing the scheduling includes tracking the order of material transports so that a first material may be transferred off a port prior to transporting a second material onto the port.

60. The method of claim 46, wherein influencing the scheduling includes dynamically reallocating a port assignment for a material transport in transit.

61. The method of claim 60, wherein influencing the scheduling further includes modifying a move appointment for the in transit material transport.

62. A program storage medium encoded with instructions that, when executed by a computing device, perform a method for use in scheduling in an automated process flow, the encoded method comprising:
scheduling on behalf of a first portion of a plurality of manufacturing domain entities for the consumption of processing services provided by a second portion of the manufacturing domain entities; and
influencing the scheduling through the management of the second portion of the manufacturing domain entities.

63. The program storage medium of claim 62, wherein scheduling on behalf of the first portion in the encoded method includes at least one of scheduling a material transport and scheduling a process operation.

64. The program storage medium of claim 62, wherein scheduling for the consumption of processing services in the encoded method includes modifying an appointment for the consumption responsive to conditions in the process flow.

65. The program storage medium of claim 62, wherein scheduling the consumption in the encoded method includes scheduling the consumption in one of initial scheduling, general scheduling, and reactive scheduling.

66. The program storage medium of claim 62, wherein influencing the scheduling in the encoded method includes:
determining a port assignment and a port availability time for a proposed material transport; and
providing the port assignment and the port availability time for use in the scheduling.

67. The program storage medium of claim 62, wherein influencing the scheduling in the encoded method includes tracking the order of material transports so that a first material may be transferred off a port prior to transporting a second material onto the port.

68. The program storage medium of claim 62, wherein influencing the scheduling in the encoded method includes dynamically reallocating a port assignment for a material transport in transit.

69. A computing system, comprising:
a computing device;
a bus system;
a storage communicating with the computing device over the bus system; and
a software application residing on the storage that, when invoked by the computing device, performs a method for use in scheduling in an automated process flow, the method comprising:
scheduling on behalf of a first portion of a plurality of manufacturing domain entities for the consumption of processing services provided by a second portion of the manufacturing domain entities; and
influencing the scheduling through the management of the second portion of the manufacturing domain entities.

70. The computing system of claim 69, wherein scheduling on behalf of the first portion in the method includes at least one of scheduling a material transport and scheduling a process operation.

71. The computing system of claim 69, wherein scheduling for the consumption of processing services in the method includes modifying an appointment for the consumption responsive to conditions in the process flow.

72. The computing system of claim 69, wherein scheduling the consumption in the method includes scheduling the consumption in one of initial scheduling, general scheduling, and reactive scheduling.

73. The computing system of claim 69, wherein influencing the scheduling in the method includes:
determining a port assignment and a port availability time for a proposed material transport; and
providing the port assignment and the port availability time for use in the scheduling.

74. The computing system of claim 69, wherein influencing the scheduling in the method includes tracking the order of material transports so that a first material may be transferred off a port prior to transporting a second material onto the port.

75. The computing system of claim 69, wherein influencing the scheduling in the method includes dynamically reallocating a port assignment for a material transport in transit.

76. A method for use in scheduling in an automated process flow, the method comprising:
scheduling a material transport in the process flow;
executing the scheduled material transport; and
dynamically reallocating a port assignment during the execution of the scheduled material transport.

77. The method of claim 76, further comprising scheduling a process operation.

78. The method of claim 76, wherein scheduling the material transport includes scheduling on behalf of a lot of silicon-based wafers or for a reticle.

79. The method of claim 76, wherein scheduling the material transport includes modifying an appointment for the scheduled material transport.

80. The method of claim 76, wherein executing the scheduled material transport includes requesting a staging of a vehicle for a scheduled material transport a predetermined time period prior to the material transport.

81. The method of claim 76, wherein executing the scheduled material transport includes tracking the order of material transports so that a first material may be transferred off a port prior to transporting a second material onto the port.

82. The method of claim 76, wherein scheduling the material transport includes a software scheduling agent representing a manufacturing domain entity calling a software implemented move appointment scheduler.

83. The method of claim 76, wherein scheduling the material transport includes scheduling in one of initial scheduling, general scheduling, and reactive scheduling.

84. The method of claim 76, further comprising:
determining a port assignment and a port availability time for a proposed material transport; and
providing the port assignment and the port availability time for use in the scheduling.

85. The method of claim 84, wherein scheduling the consumption includes scheduling a material transport with a delivery to a port identified in the port assignment at the port availability time.

86. The method of claim 76, wherein further comprising tracking the order of material transports so that a first material may be transferred off a port prior to transporting a second material onto the port.

87. A method for use in scheduling in an automated process flow, the method comprising:
determining a port assignment and a port availability time for a proposed material transport; and
providing the port assignment and the port availability time for use in scheduling a material transport; and
scheduling the material transport in the process flow for delivery to the assigned port at the port availability time.

88. The method of claim 87, wherein scheduling the material transport includes scheduling ahead an appointment for the material transport.

89. The method of claim 87, wherein scheduling the material transport includes scheduling one of a material transport from a first process tool to a first process resource, from the first process resource to a second process tool, from the first process resource to a second process resource, from a second process resource to a second process tool, and from the first process tool to the second process tool.

90. The method of claim 89, wherein at least one of the first process resource and the second process resource comprises one of a work-in-progress stocker, a wafer sorter, a work-in-progress rack, and an undertrack storage.

91. The method of claim 87, wherein scheduling the material transport for a material includes scheduling the material transport for a lot of silicon-based wafers or for a reticle.

92. The method of claim 90, wherein at least one of the first process tool and the second process tool is one of a fabrication tool and a metrology tool.

93. The method of claim 87, wherein scheduling the material transport includes setting an alarm for requesting the material transport.

94. The method of claim 87, wherein scheduling the material transport includes modifying an appointment for the material transport responsive to conditions in the process flow.

95. The method of claim 94, wherein modifying the appointment includes shifting the material transport earlier in time, shifting the material transport later in time, expanding the time for the appointment, shrinking the time for the appointment, modifying the appointment with one of a new destination or arrival time during the appointment, aborting the appointment and scheduling a new appointment, and canceling and re-scheduling the appointment.

96. The method of claim 87, further comprising executing the scheduled material transport.

97. The method of claim 96, wherein executing the material transport includes dynamically reallocating a port assignment for the destination.

98. The method of claim 87, further comprising scheduling a processing operation for the material.

99. The method of claim 87, wherein scheduling the material transport includes a software scheduling agent representing the material calling a software implemented move appointment scheduler.

100. The method of claim 87, wherein scheduling the material transport includes scheduling the material transport in one of initial scheduling, general scheduling, and reactive scheduling.

101. The method of claim 87, further comprising tracking the order of material transports so that a first material may be transferred off a port prior to transporting a second material onto the port.

102. The method of claim 87, further comprising dynamically reallocating a port assignment for a material transport in transit.

103. The method of claim 102, wherein scheduling the material transport includes modifying a move appointment for the in transit material transport.
